(19) United States
(12) Patent Application Publication
(10) Pub. No.: US 2015/0166782 A1
(43) Pub. Date: Jun. 18, 2015

(54) POLYKETONE COMPOSITE COMPOSITION

(71) Applicants: Hyundai Motor Company, Seoul (KR); Desco Co., Ltd., Chilgok-Gun (KR); Hyosung Corporation, Seoul (KR)

(72) Inventors: Choon Soo Lee, Seoul (KR); Seok Hwan Kim, Suwon (KR); Jong Hwal Kim, Daegu (KR); Sung Kyoun Yoon, Suwon (KR); Ka Young Kim, Incheon (KR); Dong Wook Kim, Daejeon (KR)

(21) Appl. No.: 14/313,415

(22) Filed: Jun. 24, 2014

(30) Foreign Application Priority Data
Dec. 17, 2013 (KR) 10-2013-0156934

(51) Int. Cl. C08L 61/02

(52) U.S. Cl. CPC C08L 61/02

(57) ABSTRACT

A polyketone composite composition is provided that includes polyketone, nylon 6, kaolin, a glass bubble, and tricalcium phosphate. The polyketone composite composition has substantially low specific gravity, and improved physical properties such as high mechanical strength, chemical resistance, gas barrier property, wear resistance, high toughness, and impact resistance, and price competitiveness, and thus may be extensively applied to interior and exterior parts of vehicles, home appliances, and the like.

### CROSS-REFERENCE TO RELATED APPLICATION

This application claims under 35 U.S.C. §119(a) the benefit of Korean Patent Application No. 10-2013-0156934 filed on Dec. 17, 2013, the entire contents of which are incorporated herein by reference.

### TECHNICAL FIELD

The present invention relates to a polyketone composite composition having substantially low specific gravity, improved physical properties, such as high mechanical strength, chemical resistance, gas barrier property, wear resistance, high toughness, and impact resistance, and price competitiveness. In particular, the polyketone composite according to the present invention may contain kaolin, a glass bubble, and tricalcium phosphate in predetermined amounts in a blend composition of polyketone and nylon 6, thereby being applied to interior/exterior parts of vehicles, home appliances, and the like.

### BACKGROUND

Recently, the vehicle industry has been more environmentally-friendly through subdivision of research and development. Further, in accordance with outstanding development of new regenerable energy and green energy resources, there has been a growing demand for reducing a weight of such vehicle, for example, a hybrid vehicle, an electric vehicle, and a hydrogen vehicle which use novel energy, to improve fuel efficiency. Therefore, a main issue of the vehicle part industry may be improving fuel efficiency by reducing the weight of goods while maintaining environmentally-friendly aspects, such as reduction exhaust of carbon dioxide.

Meanwhile, polyketone (PK) is a novel industrial material having high mechanical strength; high functionality such as chemical resistance, gas barrier property, wear resistance, high toughness, and impact resistance; and price competitiveness (low-priced raw material olefin, high toughness, and impact resistance; and price competitiveness (low-priced raw material olefin, CO). Therefore, the polyketone material is capable of replacing the existing engineered plastics for various purposes such as vehicle parts, and industrial/home machines, electric/electronic parts, and may create novel markets. Particularly, since the vehicle parts, such as interior/exterior materials, power trains, and chassis parts, require high performance, chemical resistance and reduction in weight, the polyketone composite material may be extensively applied.

Since polyketone has a structure of a three-membered or more copolymer consisting of carbon monoxide, an ethylenically unsaturated compound, and one or more olefinically unsaturated hydrocarbon compounds. Particularly, the structure thereof has repeating units of the carbon monoxide, the ethylenically unsaturated compound, and the propylenically unsaturated compound which are substantially alternately connected. Further, the polyketone has excellent mechanical and thermal properties, excellent processability, high wear resistance, chemical resistance, and gas barrier property and is useful for various purposes. In some cases, a high molecular weight polyketone material of the three-membered or more copolymer polyketone has higher processability and thermal property and is useful as an engineered plastic material having excellent economic feasibility. Particularly, the high molecular weight polyketone material may be used in parts such as gears of vehicles due to high wear resistance; in a lining material of a chemical transportation pipe and the like due to high chemical resistance; and in a lightweight gasoline tank and the like, due to high gas barrier property.

In some related arts, a blend composition of polyketone and nylon 6 and a method of manufacturing a composite using the same have been reported. Since the physical properties of the blend polyketone composite, as for example, impact resistance, heat resistance, flame resistance, and absorption resistance, are improved, when the composite is applied to engines, chassis, and exterior parts for vehicles, and the like, significant effects of improving durability and reducing overall cost may be expected. However, even though the composition of polyketone and nylon 6 provides improved durability, there still are limitations in improving fuel efficiency by reducing weight of such composite materials and improving environmentally-friendly property by reducing exhaust of carbon dioxide.

Accordingly, there is a demand for a polyketone composite composition that has both improved physical properties and that may reduce a weight.

The above information disclosed in this Background section is only for enhancement of understanding of the background of the invention and therefore it may contain information that does not form the prior art that is already known in this country to a person of ordinary skill in the art.

### SUMMARY

The present invention provides an environmentally-friendly composite material having improved physical properties, such as high mechanical strength, chemical resistance, gas barrier property, wear resistance, high toughness, and impact resistance, and being capable of reducing weight of goods due to low specific gravity, to replace the existing plastic nylon material. In particular, when kaolin, a glass bubble, and tricalcium phosphate are mixed in predetermined amounts with polyketone and nylon 6, the physical properties can be improved and low specific gravity may be achieved.

Therefore, the present invention provides technical solutions to the above-described problems associated with prior art, and provides a polyketone composite composition having both excellent physical properties and low specific gravity. Further, the present invention also provides a formed article that is manufactured by extruding or injection molding the polyketone composite composition and has low specific gravity of about 1.1 to 1.5.

In one aspect, the present invention provides a polyketone composite composition that may include: polyketone; nylon 6; kaolin; a glass bubble; and tricalcium phosphate. In another aspect, the present invention provides a formed article that may be manufactured by extruding or injection molding a polyketone-nylon 6 blend composition.

The polyketone composite composition according to an exemplary embodiment of the present invention may provide an environmentally-friendly composite material that has improved physical properties such as impact resistance, heat resistance, flame resistance, and absorption resistance and thus can be applied to engines, chassis, and interior and exterior parts for vehicles, and the like. Furthermore, the polyketone composite having substantially low specific gravity may reduce carbon dioxide in vehicle exhaust gas and improve fuel efficiency by reducing weight.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 illustrates an exemplary three-dimensional hollow structure of a glass bubble according to one exemplary embodiment of the present invention;

FIG. 2 is an exemplary correlation diagram between a change in specific gravity value and an amount of glass bubbles according to an Example and Comparative Examples 1 to 4 of the present invention; and

FIG. 3 is an exemplary correlation diagram between a specific gravity value and an use amount of the glass bubbles according to the Example and Comparative Example 4 of the present invention.

It should be understood that the accompanying drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment. In the figures, reference numbers refer to the same or equivalent parts of the present invention throughout the several figures of the drawing.

### DETAILED DESCRIPTION

it is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric, vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter reference will now be made in detail to various exemplary embodiments of the present invention, examples of which are illustrated in the accompanying drawings and described below. While the invention will be described in conjunction with exemplary embodiments, it be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, the present invention will be described in more detail as an exemplary embodiment.

In one exemplary embodiment of the present invention, a polyketone composite composition may include polyketone, nylon 6, kaolin, a glass bubble, and tricalcium phosphate. In particular, based on (A) 100 parts by weight of polyketone, (B) 1 to 40 parts by weight of nylon 6; (C) 1 to 40 parts by weight of the kaolin; (D) 1 to 30 parts by weight of the glass bubble; and (E) 0.1 to 5 parts by weight of tricalcium phosphate may be included.

(A) Poly-ketone used as base component in the present invention has excellent mechanical and thermal properties and processability, and high wear resistance, chemical resistance, and gas barrier property, and thus may be useful for various purposes. Further, (B) Nylon 6 used in the present invention is an engineered plastic having excellent heat resistance and oil resistance. Thus, nylon 6 has been widely used in engine/chassis/interior and exterior plastic parts for vehicles, and the like, in exemplary embodiments, nylon 6 may be used in a content of about 1 to 40 parts by weight based on 100 parts by weight of polyketone. When the content of nylon 6 is less than 1 part by weight, mechanical strength may decrease, and when the content is greater than 40 parts by weight, deformation problem may occur due to an increase in absorption of moisture. Thus, in exemplary embodiments, the content of nylon 6 may be within the range of about 1 to 40 parts by weight based on 100 parts by weight of polyketone.

(C) Kaolin used in the present invention may include kaolinite and halloysite as main components, and may improve mechanical strength and reduce shrinkage. When the content of kaolin is less than 1 part by weight based on 100 parts by weight of polyketone, the mechanical strength may decrease and shrinkage may increase, and when the content of kaolin is greater than 40 parts by weight, the reduction effect in weight may be insufficient due to the high specific gravity of kaolin. Therefore, in exemplary embodiments, the content of kaolin may be within the range of about 1 to 40 parts by weight based on 100 parts by weight of polyketone.

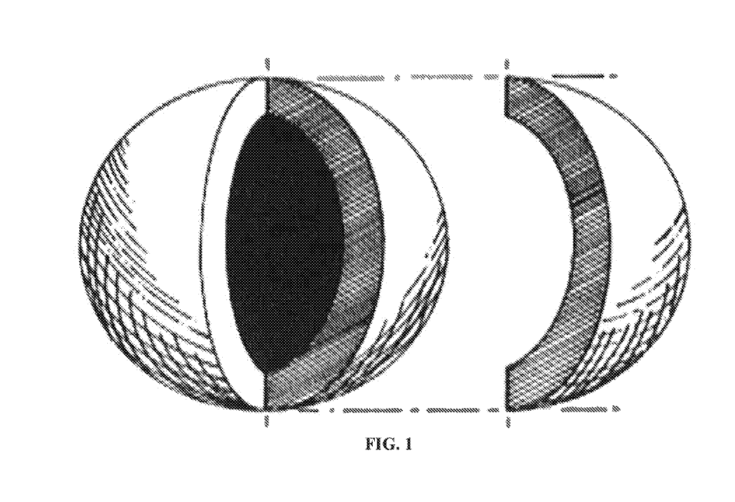

(D) The glass bubble used in the present invention is a commercially available material, and may reduce weight by reducing specific gravity of polyketone. FIG. 1 illustrates an exemplary three-dimensional hollow structure of the glass bubble, which acts like a filler having a microsphere shape and soda-lime borosilicate as a main component. In exemplary embodiments, the glass bubble may have a particle size of about 30 to 65 μm and specific gravity of about 0.125 to 0.6 g/cm³. In Table 1, the specific gravity of the glass bubble is shown in comparison to the specific gravities of other fillers which are typically used in plastics. As seen in Table 1, the specific gravity of the glass bubble is much less than those of other fillers.

TABLE 1

| | Specific gravity | | Specific gravity |
|---|---|---|---|
| Filler | (g/cm³) | Filler | (g/cm³) |
| CaCO₂ | 2.70 | Glass Fiber | 2.50 |
| Talc | 2.90 | TiO₂ | 4.10 |
| Kaolin | 2.60 | Al₂O₃ | 2.50 |
| BaSO₄ | 4.60 | Glass Beads | 2.50 |
| Mica | 2.75 | Glass bubble | 0.125~0.60 |

Thus, the weight reduction effect by reducing in specific gravity may be obtained when the glass bubble is used. Furthermore, other effects, for example, reduction in an amount of resin used, improvement of dimensional stability and deformation after forming, improvement of processability and formability, improvement of insulation performance and moisture resistance, and the like, may be expected. Accordingly, in exemplary embodiments, the glass bubble may be in a content of 1 to 30 parts by weight based on 100 parts by weight of polyketone. When the content of glass bubble is less than 1 part by weight, the reduced amount of the specific gravity may be insignificant, and the reduction effect in weight may be insufficient. When the content is greater than 30 parts by weight, mechanical strength may decrease, and the glass bubble may be within the aforementioned content range.

(E) Tricalcium phosphate (TCP) may be used as an additive to maintain viscosity of polyketone and thus minimize breakage of the glass bubble. In particular, since the viscosity of polyketone increases and polyketone is gelated at high temperatures, tricalcium phosphate may be added to maintain the viscosity of polyketone, and thus breakage of the glass bubble may be minimized to maintain the low specific gravity. Accordingly, in exemplary embodiments, tricalcium phosphate may be in a content of about 0.1 to 5 parts by weight based on 100 parts by weight of polyketone. When the content of tricalcium phosphate is less than 0.1 parts by weight, gelation of polyketone may not be suppressed, and a reduction effect in breakage of the glass bubble may be minimal. When the content is greater than 5 parts by weight, the mechanical strength may decrease due to excessive addition, and tricalcium phosphate may be within the aforementioned content range.

As described above, the polyketone composite composition according to the exemplary embodiment of the present invention has improved physical properties such as impact resistance, heat resistance, flame resistance, and absorption resistance. Accordingly, the polyketone composite composition may be extensively used in vehicle particles, as for example, interior/exterior materials, power trains, and chassis parts, and may also be applied to home appliances.

### EXAMPLES

The following examples illustrate the invention and are not intended to limit the same. Hereinafter, the present invention will be described in more detail through the Examples. However, the Examples are set forth to illustrate the present invention, but the scope of the present invention is not limited thereto. Physical properties of specimens manufactured according to Example 1 and Comparative Examples 1 to 4 were measured by the following method, and result values thereof are described in Tables 2 to 6.

### Test Example

### Measurement Method of Physical Properties

1) The tensile test was performed at the tensile speed of 5 mm/min using the specimen having the thickness of 4.0±0.2 mm, the width of 20.0±0.2 mm, and the length of 150 mm according to ISO527.

2) The bending test was performed at the test speed of 2 mm/min using the specimen having the thickness of 4.0±0.2 mm, the width of 10.0±0.2 mm according to ISO178, and the length of 80.0±0.2 mm while the support distance of 64 mm was maintained.

3) The impact strength test was performed using the notched specimen having the thickness of 4.0±0.2 mm, the width of 10.0±0.2 mm, and the length of 80.0±0.2 mm according to ISO179.

4) The specific gravity test was performed according to ISO1183.

5) The shrinkage test was performed by manufacturing the ISO shrinkage specimen by injection and using the vernier calipers.

### Example 1

### Manufacturing and Physical Property Measurement Results of the Polyketone/Nylon 6/Kaolin/Glass Bubble/Tricalcium Phosphate Composite

### Examples 11 to 1

Polyketone, nylon, and kaolin were mixed at the weight ratio of 85.5:4.5:10 according to the compositional ratio in Table 2. Then, tricalcium phosphate was added in the content of 1 part by weight to the mixture to perform blending and the composite was manufactured by melt blending while the content of the glass bubble was changed. After the injection specimens were manufactured, the physical properties thereof were measured and are described in Table 2.

In the present invention, the blended composite was added to the main hopper at 250 rpm at 230 to 235° C. by using the biaxial screw, the glass bubble was added to the side hopper by extruding, and the specimens for test were manufactured in the injection molding machine having the cylinder portion at 230 to 250° C. and the mold temperature of 80° C. under injection pressure at 40 to 200° C.

TABLE 2

| Composition (unit: parts | | Example | Example | Example |
|---|---|---|---|---|
| by weight) | | 1-1 | 1-2 | 1-3 |
| Polyketone | | 100 | 100 | 100 |
| Nylon 6 | | 5.3 | 5.3 | 5.3 |
| Kaolin | | 11.7 | 11.7 | 11.7 |
| Glass bubble | | 2 | 4 | 6 |
| Tricalcium phosphate | | 1 | 1 | 1 |
| Tensile | Strength (MPa) | 62.8 | 54.9 | 53.3 |
| property | Elongation (%) | 21.4 | 18.5 | 16.4 |
| Bending | Strength (MPa) | 72.5 | 74.3 | 75.7 |
| property | Elasticity (MPa) | 1882.0 | 1921.9 | 1946.6 |
| Impact strength (KJ/m2) | | 5.2 | 4.2 | 3.5 |
| Shrinkage | FD | 2.61 | 2.62 | 2.62 |
| (%) | TD | 2.50 | 2.44 | 2.47 |

| | | | |
|---|---|---|---|
| Specific gravity | 1.283 | 1.259 | 1.233 |

### Comparative Example 1

### Manufacturing and Physical Property Measurement Results of the Polyketone/Glass Bubble Composite

### Comparative Examples 1-1 to 1-4

The specimens were manufactured by the same method as Example 1 according to the compositional ratio of Table 3, and physical properties thereof were measured and described in Table 3.

TABLE 3

| | | Compar- | Compar- | Compar- | Compar- |
|---|---|---|---|---|---|
| | | ative | ative | ative | ative |
| Composition (unit: parts | | Example | Example | Example | Example |
| by weight) | | 1-1 | 1-2 | 1-3 | 1-4 |
| Polyketone | | 100 | 100 | 100 | 100 |
| Glass bubble | | 0 | 2 | 4 | 6 |
| Tensile | Strength | 63.6 | 57.3 | 51.5 | 47.0 |
| property | (MPa) | | | | |
| | Elongation | 148.5 | 66.7 | 55.5 | 40.3 |
| | (%) | | | | |
| Bending | Strength | 63.3 | 65.3 | 67.2 | 68.8 |
| property | (MPa) | | | | |
| | Elasticity | 1516.4 | 1677.6 | 1717.1 | 1775.3 |
| | (MPa) | | | | |
| Impact strength (KJ/m2) | | 7.3 | 5.4 | 4.6 | 4.0 |
| Shrinkage | FD | 2.34 | 2.45 | 2.41 | 2.32 |
| (%) | TD | 2.47 | 2.45 | 2.34 | 2.26 |

| | | | | |
|---|---|---|---|---|
| Specific gravity | 1.248 | 1.227 | 1.203 | 1.181 |

### Comparative Example 2

### Manufacturing and Physical Property Measurement Results of the Polyketone/Nylon 6/Glass Bubble Composite

### Comparative Examples 2-1 to 2-4

Polyketone and nylon 6 were blended at the weight ratio of 95:5 to manufacture the specimens by the same method as Example 1 according to the compositional ratio of Table 4, and physical properties thereof were measured and described in Table 4.

TABLE 4

| | | Compar- | Compar- | Compar- | Compar- |
|---|---|---|---|---|---|
| | | ative | ative | ative | ative |
| Composition (unit: parts | | Example | Example | Example | Example |
| by weight) | | 2-1 | 2-2 | 2-3 | 2-4 |
| Polyketone | | 100 | 100 | 100 | 100 |
| Nylon 6 | | 5.3 | 5.3 | 5.3 | 5.3 |
| Glass bubble | | 0 | 2 | 4 | 6 |
| Tensile | Strength | 64.7 | 59.1 | 53.6 | 49.7 |
| property | (MPa) | | | | |
| | Elongation | 118.5 | 70.4 | 56.6 | 37.5 |
| | (%) | | | | |
| Bending | Strength | 61.3 | 63.4 | 62.3 | 62.7 |
| property | (MPa) | | | | |
| | Elasticity | 1496.4 | 1552.3 | 1573.4 | 1616.4 |
| | (MPa) | | | | |
| Impact strength (KJ/m2) | | 7.4 | 5.5 | 4.9 | 4.6 |
| Shrinkage | FD | 2.33 | 2.60 | 2.63 | 2.56 |
| (%) | TD | 2.49 | 2.56 | 2.53 | 2.45 |

| | | | | |
|---|---|---|---|---|
| Specific gravity | 1.240 | 1.220 | 1.198 | 1.175 |

### Comparative Example 3

### Manufacturing and Physical Property Measurement Results of the Polyketone/Kaolin/Glass Bubble Composite

### Comparative Examples 3-1 to 3-4

Polyketone and kaolin were blended at the weight ratio of 90:10 to manufacture the specimens by the same method as Example 1 according to the compositional ratio of Table 5, and physical properties thereof were measured and described in Table 5.

TABLE 5

| | | Compar- | Compar- | Compar- | Compar- |
|---|---|---|---|---|---|
| | | ative | ative | ative | ative |
| Composition (unit: parts | | Example | Example | Example | Example |
| by weight) | | 3-1 | 3-2 | 3-3 | 3-4 |
| Polyketone | | 100 | 100 | 100 | 100 |
| Kaolin | | 11.1 | 11.1 | 11.1 | 11.1 |
| Glass bubble | | 0 | 2 | 4 | 6 |
| Tensile | Strength | 67.3 | 60.7 | 55.4 | 51.6 |
| property | (MPa) | | | | |
| | Elongation | 21.7 | 21.0 | 18.4 | 17.1 |
| | (%) | | | | |
| Bending | Strength | 71.0 | 71.7 | 72.2 | 75.0 |
| property | (MPa) | | | | |
| | Elasticity | 1867.9 | 1950.2 | 1981.6 | 2073.0 |
| | (MPa) | | | | |
| Impact strength (KJ/m2) | | 6.7 | 5.1 | 3.9 | 3.2 |
| Shrinkage | FD | 2.61 | 2.65 | 2.63 | 2.60 |
| (%) | TD | 2.53 | 2.46 | 2.44 | 2.41 |

| | | | | |
|---|---|---|---|---|
| Specific gravity | 1.320 | 1.292 | 1.272 | 1.252 |

### Comparative Example 4

### Manufacturing and Physical Property Measurement Results of the Polyketone/Nylon 6/Kaolin/Glass Bubble Composite

### Comparative Examples 4-1 to 4-4

Polyketone, nylon 6, and kaolin were mixed at the weight ratio of 85.5:4.5:10 to manufacture the specimens by the same method as Example 1 according to the compositional ratio of Table 6, and physical properties thereof were measured and described in Table 6,

TABLE 6

| | | Compar- | Compar- | Compar- | Compar- |
|---|---|---|---|---|---|
| | | ative | ative | ative | ative |
| Composition (unit: parts | | Example | Example | Example | Example |
| by weight) | | 4-1 | 4-2 | 4-3 | 4-4 |
| Polyketone | | 100 | 100 | 100 | 100 |
| Nylon 6 | | 5.3 | 5.3 | 5.3 | 5.3 |
| Kaolin | | 11.7 | 11.7 | 11.7 | 11.7 |
| Glass bubble | | 0 | 2 | 4 | 6 |
| Tensile | Strength | 68.1 | 61.5 | 56.4 | 53.3 |
| property | (MPa) | | | | |
| | Elongation | 22.3 | 21.5 | 18.9 | 16.7 |
| | (%) | | | | |
| Bending | Strength | 71.7 | 72.6 | 74.2 | 75.9 |
| property | (MPa) | | | | |
| | Elasticity | 1853.7 | 1882.0 | 1921.9 | 1946.6 |
| | (MPa) | | | | |
| Impact strength (KJ/m2) | | 6.9 | 5.3 | 4.3 | 3.7 |
| Shrinkage | FD | 2.65 | 2.61 | 2.62 | 2.62 |
| (%) | TD | 2.52 | 2.50 | 2.44 | 2.47 |

| | | | | |
|---|---|---|---|---|
| Specific gravity | 1.312 | 1.289 | 1.268 | 1.249 |

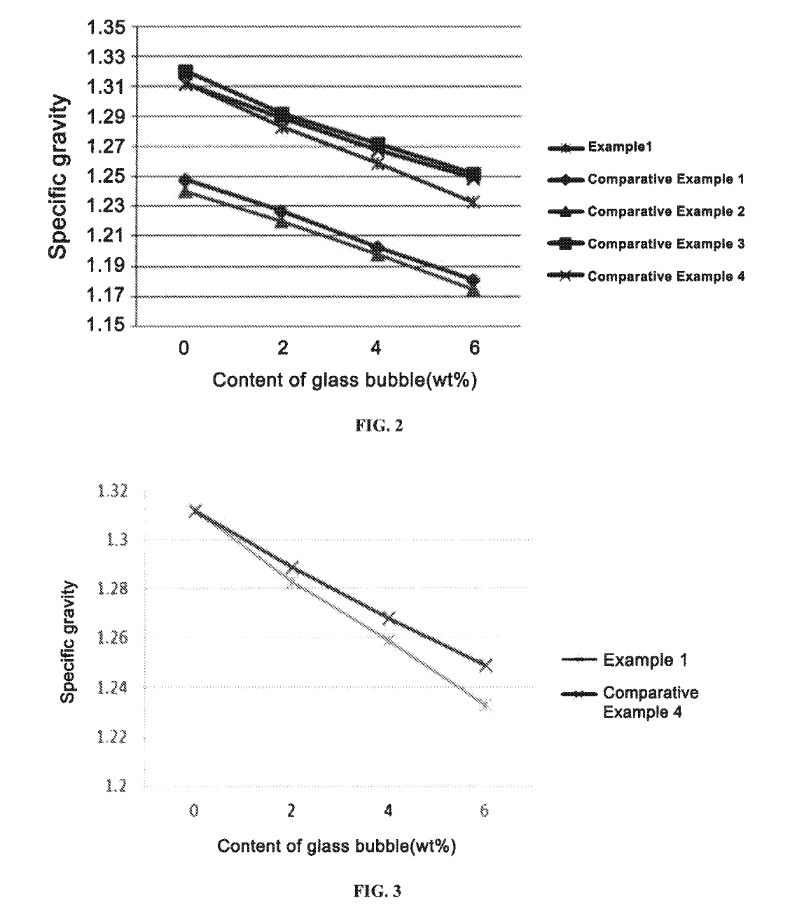

FIG. 2 illustrates the specific gravities according to the use amount of the glass bubble, and through the result values of Tables 2 to 6. Therefore, the specific gravity may be reduced as the content of the glass bubble increases and thus an improved reduction characteristic in weight may be obtained. Particularly, in Example 1, tricalcium phosphate (TCP) was added to maintain the viscosity of polyketone since the viscosity of the polyketone increases and the polyketone is gelated at high temperatures. As detailed in Example 1, by addition of tricalcium phosphate, breakage of the glass bubble may be minimized to maintain the specific gravity by maintaining the viscosity of polyketone substantially uniform. The results of comparing physical properties thereof with Comparative Example 4 are illustrated in FIG. 3.

From Tables 2-6 and FIG. 3, it is confirmed that the specific gravity with the glass bubble of Example 1 for each content is less than that of Comparative Example 4 by about 0.4 to 1.2%. In addition, tricalcium phosphate has an effect of maintaining the viscosity of polyketone to reduce gelation and minimizing breakage of the glass bubble. Accordingly, the reinforced polyketone composite composition of the present invention is highlighted in that the low specific gravity is obtained due to hollow structures of the glass bubbles and tricalcium phosphate minimizes breakage of the glass bubble to maintain the low specific gravity, thereby reducing the weight of vehicle.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A polyketone composite composition comprising:
polyketone;
nylon 6;
kaolin;
a glass bubble; and
tricalcium phosphate.

2. The polyketone composite composition of claim 1, comprising:
based on 100 parts by weight of polyketone,
about 1 to 40 parts by weight of nylon 6;
about 1 to 40 parts by weight of the kaolin;
about 1 to 30 parts by weight of the glass bubble; and
about 0.1 to 5 parts by weight of tricalcium phosphate.

3. The polyketone composite composition of claim 1, wherein the glass bubble has a particle size of about 30 to 65 μm and a specific gravity of about 0.12 to 0.6 g/cm³.

4. A formed article manufactured by compounding and extruding or injection molding the polyketone composite composition of claim 1.

5. The formed article of claim 4, wherein the formed article has a specific gravity of about 1.1 to 1.5 g/cm³ and is used for interior and exterior parts of vehicles.
